(19) United States
(12) Patent Application Publication
(10) Pub. No.: US 2005/0076565 A1
(43) Pub. Date: Apr. 14, 2005

(54) Container garden

(76) Inventor: Linda S. Terrell, Santa Cruz, CA (US)

Correspondence Address: M. REID RUSSELL, 854 WEST 3390 SOUTH, HURRICANE, UT, 84737, US

(21) Appl. No.: 10/683,681

(22) Filed: Oct. 14, 2003

(51) Int. Cl. A01G 9/02

(52) U.S. Cl. 47/65.8

(57) ABSTRACT

A container garden for producing seedlings for grazing by a pet, in particular a cat. The invention consists of a container and closure therefor and a sack formed from a mesh material, such as a nylon stocking material, that a mixture of a plant growing medium, such as mix of potting soil and vermiculite, and selected seeds, such as wheat, barley, oats, rye and catnip seeds, are maintained in, and the sack is closed into a pouch for fitting into the container that receives a lid fitted thereto. The container is to receive and hold water to sprout the seeds that grow into seedlings that pass through the mesh material openings.

### BACKGROUND OF THE INVENTION

1. Field of the Invention

The present invention relates to containers and systems for sprouting seeds into eatable young seedlings, for consumption, and in particular for consumption by cats.

2. Prior Art

Containers for sprouting seeds, as in a kitchen, that provide humans and/or animals with edible sprouts are well known and in common use. Such containers often include a sprouting medium, such as a bottom liner, that the seeds rest on and keep the seeds out of water as collects on the container floor, discouraging seed rotting. Sprouting jars, and the like, having caps that including a plurality of holes to admit air into the jar during the sprouting process are also in common use. None, however, have includes, as does the invention, a nutrient source surrounding the seeds to provide for a continuing seedling grown even with continued grazing or leaf cutting from the sprouted seeds, nor has any other sprouting system provided, as does the invention, an open weave material pouch for containing and maintaining the mix of plant nutrients and seeds in a cohesive state during growing sprouting and with continuing cuttings.

### SUMMARY OF THE INVENTION

The invention is in a container garden that consists of a plastic container having a bottom, upstanding side walls, and preferably includes a cover, and with the cover to hold a closed pouch that is preferably formed from a mesh material, such as a section of nylon stocking material. The pouch is closed to contain a mixture of a growth medium, such as potting soil, and a variety of seeds that are selected to have different germination periods. With a preferred mix of seeds being wheat, barley, oats, rye and catnip to provide early and slower sprouting seeds, producing a early and continuing growth that can be harvested by an animal, such as a cat, who grazes the new growth of seedlings as have grown through the mesh material.

It is a principal object of the present invention to provide a renewing seedling source for a pet, particularly a cat, to periodically graze on where the new growth is passes through a mesh sack or bag arrangement that surrounds a growth medium and seed ball that is maintained in a dish type container.

Another object of the present invention is to provide a combination of a sprouting container that accommodates a porous sack or bag containing a mix of a growth medium, such as potting soil and vermiculite, with a mixture of sprouting seeds, where the seeds are selected to germinate at lengthening time periods, providing a renewing seedling source for a pet, particularly a cat, to graze on.

Still another object of the present invention is to provide a seedling source for a pet, such as a cat, to graze upon, that is a combination of a sprouting container wherein is maintained a seedling source that is a mixture of selected seeds and a growth medium that is contained in a closed porous sack or pouch that is formed from a materials, such as a section of a nylon material, where the grow medium is a mix of approximately one part potting soil and three parts vermiculite and the preferred selected seeds are wheat, barley, oats, rye and catnip seeds that germinate at different time intervals, providing a continuing seedling source.

### BRIEF DESCRIPTION OF THE DRAWINGS

These and other objects and features of the present invention will become more apparent from the following description in which the invention is described in detail in conjunction with the accompanying drawings:

FIG. 1 is a side elevation view of a cat shown grazing upon a seedling growth that extends out from a surface of a pouch maintained in a container of the invention, with the pouch containing a mix of seeds and growth medium;

FIG. 2 shows a side elevation view of the wide mouth low profile plastic container with the pouch of FIG. 1, which container has received periodic watering and been exposed to light to successively germinate the different varieties of seeds as are contained in the pouch, sprouting the seeds into seedlings that grow through the pouch mesh;

FIG. 3 is a view like that of FIG. 1 only showing the pouch as having been removed from the container;

FIG. 4 shows a vertically exploded perspective view of the container with lid and pouch containing the growth material and varieties of seeds of the invention;

FIG. 5 shows a view like that of FIG. 4 without the container and lid, and showing the pouch as having been opened and the growth medium and seeds separated, with the seeds shown on top of the growth medium;

FIG. 6 shows a block flow of the steps involved in forming the pouch containing the growth medium and seeds;

FIG. 7 shows a block flow of the steps involved in activating the invention to produce a continuing seedling growth for grazing by an animal, such as the cat, as shown in FIG. 1.

### DETAILED DESCRIPTION

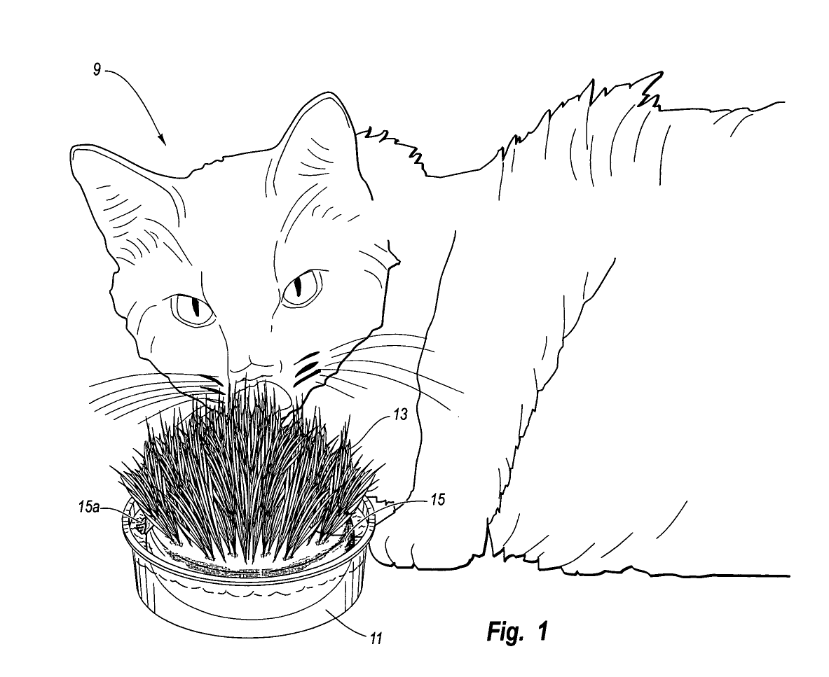

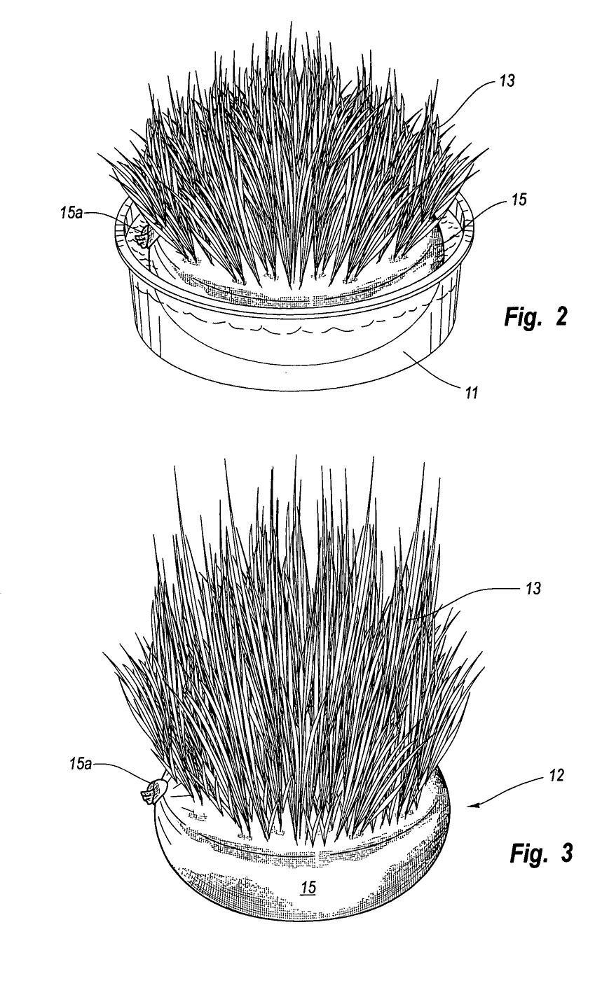

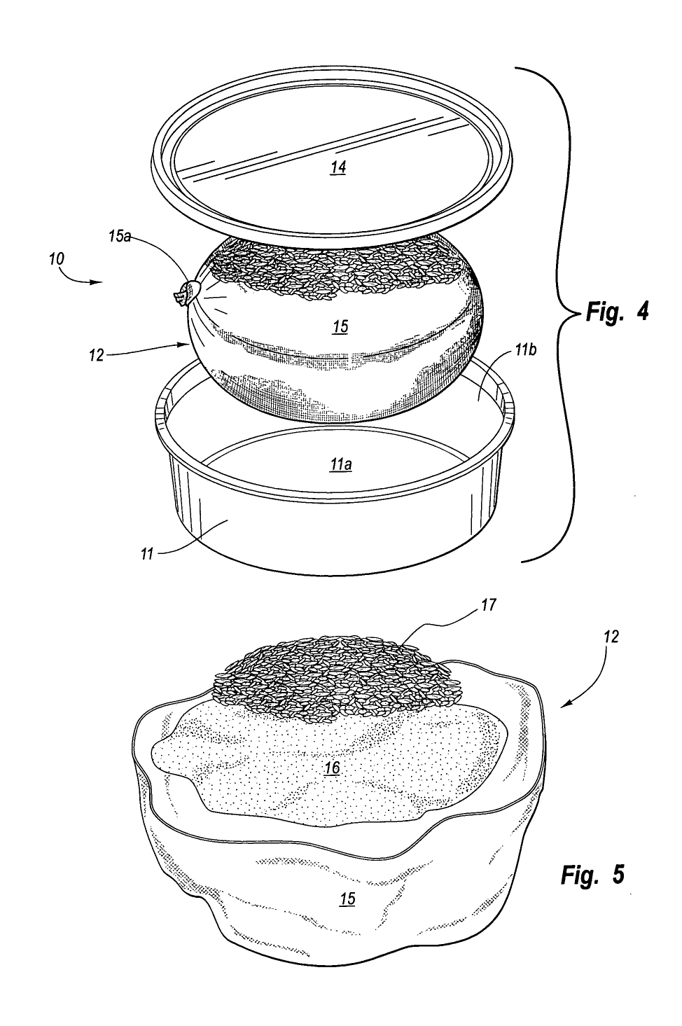

The invention, as is hereinafter described, relates to sprouting systems and provides an arrangement to produce a continuing source of seedling for an animal to graze upon, particularly a cat. A cat 9 is shown in FIG. 1, about to graze on shoots or seedlings 13 grown from various seeds that are shown as having passed out of openings in a nylon mesh material 15 that is formed into a pouch 12 and is tied on end 15a. The pouch 12 contains a mixture of a growth medium and seeds. FIG. 1 shows the cat 9 as nibbling on the seedlings or shoots 13 that extend out of the mesh material 15 top surface. The pouch 12 is shown in FIGS. 2 and 4 as formed for containment in a container 11 of the container garden 10 of the invention, that, as shown in FIG. 4, preferable includes a cover 14. For grazing new growth or shoots off of the pouch 12 surface, the pouch can be left in the container 11 of FIGS. 2 and 4, where it is kept moist, or can be removed from the container to also serve also as a pet toy.

FIG. 4 shows the container garden 10 as including the container 11 that preferably has a flat bottom 11a, with upstanding side walls 11b, and can receive a top 14 fitted there over. The top 14 is essentially for maintaining the pouch 12 in the container during shipping and handling, and the container is left open, as illustrated in FIG. 2, during the sprouting process.

The pouch 12, as shown in FIGS. 1 through 5, is a closed sack 15 that is preferably formed from a nylon stocking material though, it should be understood, another type of cloth having closed spaced openings could be so used within the scope of this disclosure. The sack 15 is closed at its end 15a and is filled, as shown best in FIG. 5, with a growth medium 16 that is preferably a mixture of one part potting soil and three parts vermiculite, and includes a seeds 17 mixed therein. The growth medium and seeds are show separated in FIG. 5, and, it should be understood, are thoroughly mixed together in practice. A preferred composition of seeds 17 is selected to provide quick or early initial sprouting that includes slower sprouting other seeds, providing a continuous growth and regrowth over a significant period of time. In practice, a mix of wheat, barley, oats, rye and catnip seeds have been found to provide a fast and continued sprouting that allows a pet, such as a cat, to graze daily over a number of days, with the pouch 12 holding together to also allow it to be used as a toy by that cat between grazings.

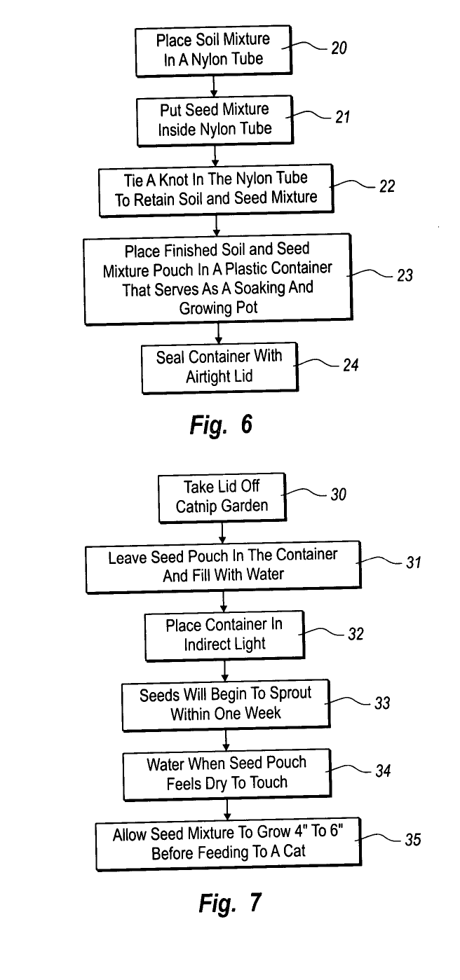

As shown in the block flow schematic of FIG. 6, the invention in a container garden 10 is fabricated, shown in block 20, by first placing a soil mixture 16, shown in FIG. 4, in a nylon sack 15, shown in FIG. 5, and then mixing seeds 17, shown in block 21, in that soil mixture inside the nylon sack. Shown in block 22, the nylon sack 15 is closed at 15a, shown in FIGS. 2, 3 and 4, preferably by tying a knot in that nylon sack end. Shown in block 23, the filled and knotted nylon sack is then place in plastic container 11, and, as shown in block 24, lid 14 is fitted thereover, as shown in FIG. 4.

To energize the pouch containing the seed and soil mixture in the nylon tube pouch and begin the sprouting process, as shown in FIG. 7, the container lid is removed, as shown in block 30, and the container is filled with water, shown at block 31. The water filled container is placed in indirect light, shown as block 33.

After approximately one week, the faster germinating of the seeds 17 will begin to sprout, shown at block 33. Thereafter, to continue the sprouting process, with the seedlings growing through the pouch pores or openings, water is added to the container containing the pouch when the pouch exterior feels dry to the touch, as shown at block 34. In which sprouting and seedling growth process, the seedlings should be allowed to grow to approximately four to six inches before allowing a cat or other pet to graze, as shown at block 35.

Hereinabove has been set out a description of a preferred container garden of the invention. It should however, be understood that the present invention can be varied within the scope of this disclosure without departing from the subject matter coming within the scope of the following claims, and a reasonable equivalency thereof, which claims I regard as my invention.

1. A container garden comprising, a container having a bottom and upstanding side wall and is arranged to receive a lid fitted thereover, a sack formed from a flexible cloth mesh material that is open at one end to receive a mixture of a growth medium and selected seed and is closed at said end into a pouch of a size to fit in and essentially fill said container and be easily removable therefrom for repositioning in the container and for use as a cat toy.

2. The container garden as recited in claim 1, wherein the sack is formed from a nylon stocking material and is filled to maintain a round shape when removed from the container.

3. The container garden as recited in claim 1, wherein the growth medium is a mixture of one part potting soil and three parts vermiculite.

4. The container garden as recited in claim 1, wherein the selected seed are wheat, barley, oats, rye and catnip seeds.

5. The container garden as recited in claim 1, wherein the container and lid are each formed from a plastic material.
